(19) United States
(12) Patent Application Publication
(10) Pub. No.: US 2016/0288406 A1
(43) Pub. Date: Oct. 6, 2016

(54) SCREEN PROTECTING FILM INCLUDING COLORED ADHESIVE SURFACE PROTECTING LAYER AND PERFORATED LINE AND METHOD FOR ATTACHING THE SCREEN PROTECTING FILM USING THE ADHESIVE SURFACE PROTECTING LAYER AND THE PERFORATED LINE

(71) Applicant: MI AE KANG, Yongin-si (KR)

(72) Inventor: MI AE KANG, Yongin-si (KR)

(21) Appl. No.: 15/070,541

(22) Filed: Mar. 15, 2016

(30) Foreign Application Priority Data
Mar. 30, 2015 (KR) 10-2015-0044517

(51) Int. Cl. B29C 63/00; H04B 1/3888

(52) U.S. Cl. CPC B29C 63/0004; H04B 1/3888; B29L 2031/3475

(57) ABSTRACT

According to an embodiment of the present disclosure, a screen protecting film includes a protecting layer and an adhesive surface protecting layer formed on a surface of the protecting layer. The screen protecting film may further comprise a screen film formed on a surface of the adhesive surface protecting layer. An adhesive may be applied to a surface of the screen film, thus forming an adhesive surface. The adhesive surface may be formed between the adhesive surface protecting layer and the screen film. The adhesive surface protecting layer may have a color. The adhesive surface protecting layer may include a perforated line and a cut-off portion. The perforated line of the adhesive surface protecting layer may be a straight line crossing the adhesive surface protecting layer in a width direction of the adhesive surface protecting layer.

### CROSS-REFERENCE TO RELATED APPLICATIONS

This patent application claims priority under 35 U.S.C. §119 to Korean Patent Application No. 10-2015-0044517, filed on Mar. 30, 2015, in the Korean Intellectual Property Office, the disclosure of which is incorporated by reference herein in its entirety.

### TECHNICAL FIELD

The disclosure relates to protecting the screen of mobile devices, and more specifically, to a screen protecting film for a mobile device, including a colored adhesive surface protecting layer and a perforated line and a method for attaching the screen protecting film using the adhesive surface protecting layer and the perforated line.

DISCUSSION OF RELATED ART

A mobile device, e.g., a mobile phone, includes a display displaying various types of images on the screen. The screen of the mobile device may be vulnerable to scratches or damage that may occur while the user carries the mobile device in his pocket or bag. A protecting film may be attached to the screen to protect the screen against such scratches or damage.

Referring to FIG. 1, a conventional protecting film for mobile devices may include a screen film 12, an adhesive surface protecting film 11 attached onto the bottom of the screen film 12, a protecting film 13 attached onto the top of the screen film 12, and tabs 14 and 15 respectively provided at sides of the protecting film 13 and the adhesive surface protecting film 11.

An adhesive surface is formed on the surface of the screen film 12 that is to be attached to the screen of the mobile device. The adhesive surface protecting film 11 may protect the adhesive surface of the screen film 12, and the protecting film 13 may be attached to the top of the screen film 12 to protect the screen film 12.

To attach the conventional screen protecting film, the user partially peels off the tab 15 as shown in FIG. 2 and casually sticks a portion of the screen film 12 to the screen of the mobile device. The user then determines an exact position of attachment and peels off the tab 15 and attaches the screen film 12 to the screen of the mobile device.

Then, the user removes the protection film 13 from the upper Portion of the screen film 12 by pulling up the tab 14, finishing the attachment of the screen film 12.

However, it is not easy to attach the screen film 12 in place on the screen of the mobile device, sometimes causing air bubbles and influx of dust into the space between the screen film 12 and the screen.

### SUMMARY

According to embodiments of the present disclosure, a screen film may be attached in place onto the screen of a mobile device in an easier and more convenient manner without repetitive trials and errors.

According to an embodiment of the present disclosure, a screen protecting film includes a protecting layer and an adhesive surface protecting layer formed on a surface of the protecting layer. The screen protecting film may further comprise a screen film formed on a surface of the adhesive surface protecting layer. An adhesive may be applied to a surface of the screen film, thus forming an adhesive surface. The adhesive surface may be formed between the adhesive surface protecting layer and the screen film. The adhesive surface protecting layer may have a color. The adhesive surface protecting layer may include a perforated line and a cut-off portion. The perforated line of the adhesive surface protecting layer may be a straight line crossing the adhesive surface protecting layer in a width direction of the adhesive surface protecting layer. The perforated line may separate the cut-off portion from the rest of the adhesive, surface protecting layer. The cut-off portion may be cut or removed off along the perforated line.

The screen protecting film may have a top and bottom edge respectively corresponding in shape to an upper and lower portion of the screen of the mobile device, wherein, e.g., a camera lens or speaker may be positioned in the upper portion of the screen, and, e.g., a home button or power button may be positioned in the lower portion of the screen. The screen film may be attached onto the screen of the mobile device, with the upper or lower edge of the screen protecting film placed consistent with the upper or lower portion of the screen. The perforated line may be positioned close to an upper or lower portion of the adhesive surface protecting layer.

The adhesive surface protecting layer may be formed between the protecting layer and the screen film.

According, to an embodiment of the present disclosure, method for attaching a screen protecting film onto a screen of a mobile phone using a colored adhesive surface protecting layer and a perforated line may comprise removing a cut-off portion along the perforated line, determining and adjusting a position of attachment of a screen film fitting an edge of a speaker area in an upper portion of the mobile phone using a portion of a screen film exposed by removing the cut-off portion and a remaining portion of the colored adhesive surface protecting layer, placing an adhesive surface of the exposed portion of the screen film, which corresponds to the cut-off portion, to correspond to the edge of the speaker area and attaching the exposed adhesive surface to an upper portion of a screen of the mobile phone, removing the remaining portion of the colored adhesive surface protecting layer with the screen film attached and fixed to the upper portion of the screen of the mobile phone, and attaching a remaining portion of the screen film to the screen of the mobile phone after the adhesive surface protecting layer is removed.

A protecting layer may be formed under the adhesive surface protecting layer. The method may further comprise removing the protecting layer before removing the cut-off portion.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a cross-sectional view illustrating a screen protecting film for a mobile phone according to the related art;

FIG. 2 is a perspective view illustrating a screen protecting film for a mobile phone according to the related art;

FIG. 3 is a perspective view illustrating a screen protecting film for a mobile phone according to an embodiment of the present disclosure;

FIG. 4 is a cross-sectional view taken along line A-A of FIG. 3; and

FIGS. 5 to 9 are views illustrating a process for sequentially attaching a screen protecting film onto a mobile phone according to an embodiment of the present disclosure.

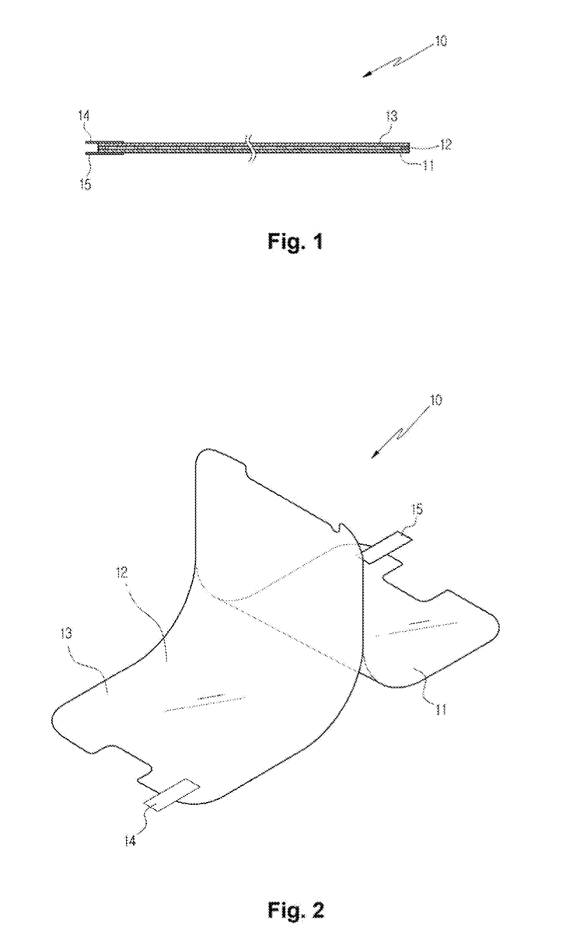

### DETAILED DESCRIPTION OF THE DRAWINGS

Hereinafter, exemplary embodiments of the inventive concept will be described in detail with reference to the accompanying drawings. The inventive concept, however, may be modified in various different ways, and should not be construed as limited to the embodiments set forth herein. As used herein, the singular forms “a,” and the are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

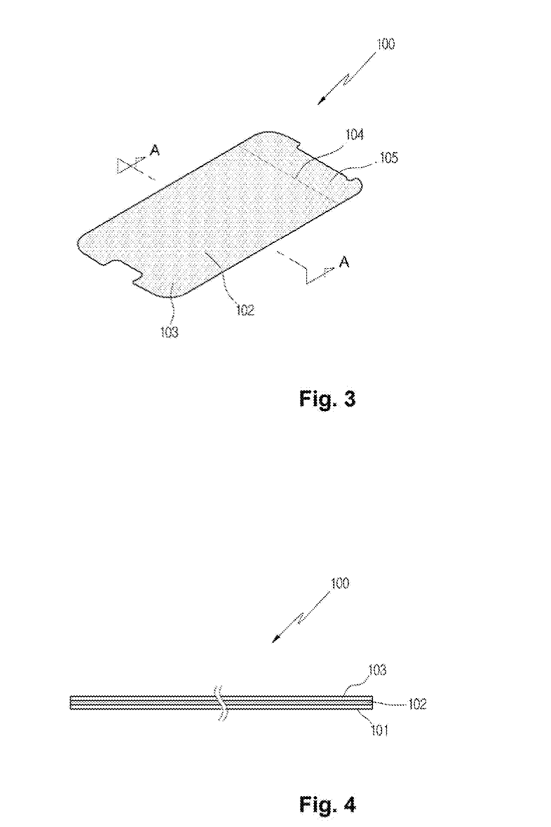

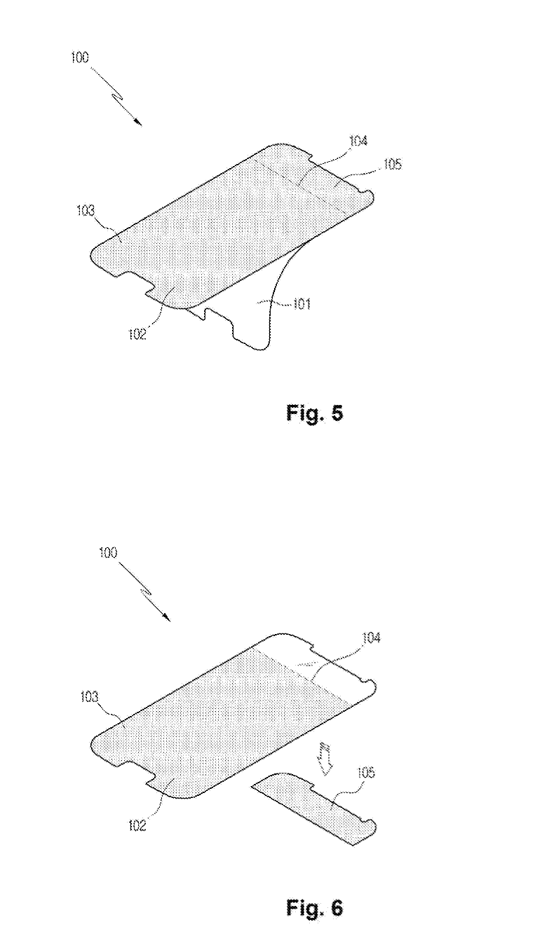

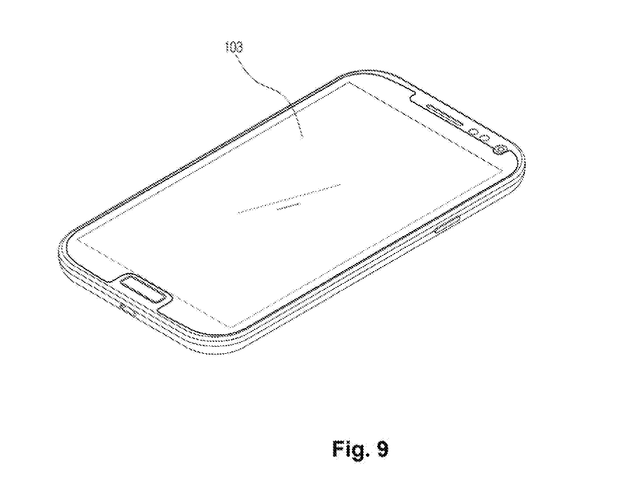

FIG. 3 is a perspective view illustrating a screen protecting film for a mobile phone according to an embodiment of the present disclosure. FIG. 4 is a cross-sectional view taken along line A-A of FIG. 3. FIGS. 5 to 9 are views illustrating a process for sequentially attaching a screen protecting film onto a mobile phone according to an embodiment of the present disclosure.

According to an embodiment of the present disclosure, the screen protecting film 100 for a mobile device (e.g., a mobile phone) may include a screen film 103 (e.g., a liquid crystal display (LCD) screen film), an adhesive surface protecting layer 102 attached on a first surface of the screen film 103, and a protecting layer 101 attached on a first surface of the adhesive surface protecting layer 102. For example, the first surface of the screen film 103 may be the bottom of the screen film 103. For example, the first surface of the adhesive surface protecting layer 102 may be the bottom of the adhesive surface protecting layer 102.

The screen film 103 may be attached onto the screen of the mobile device (e.g., the LCD or OLED display of the mobile device) to prevent scratches or damage to the screen of the mobile device. The adhesive surface protecting layer 102 may be a protecting film to protect an adhesive surface formed on the first surface (e.g., bottom) of the screen film 103 for attaching to the screen of the mobile phone. The adhesive surface protecting layer 102 may have a color to identify the position of the attachment on the screen of the mobile phone. The protecting layer 101 may preserve or maintain the original shape of the adhesive surface protecting layer 102.

Referring to FIG. 3, the screen protecting film 100 may include a cut-off portion 105 at a side thereof, which is divided by a perforated line 104. The perforated line 104 and the cut-off portion 105 may be formed in the adhesive surface protecting layer 102. The perforated line 104 may be positioned close to an upper or lower portion of the adhesive surface protecting layer 102. The perforated line 104 may separate the cut-off portion 105 from the rest of the adhesive surface protecting layer 102. The cut-off portion 105 may be cut or removed off along the perforated line 104.

The protecting layer 101 may be attached on the first surface (e.g., the bottom) of the adhesive surface protecting layer 102 having the perforated line 104 and the cut-off portion 105, preventing the cut-off portion 105 cut along the perforated line 104 from escaping off.

The adhesive surface protecting layer 102 may protect the adhesive surface of the screen film 103. Thus, upon attachment of the screen film 103 to the screen of the mobile phone, the adhesive surface protecting layer 102 may prevent dust or other foreign bodies from sticking to the adhesive surface of the screen film 103.

Now described is a process for attaching a screen protecting film 100 onto the screen of a mobile phone according to an embodiment of the present disclosure.

Referring to Fig, 5, the protecting layer 101 is removed, which is formed at the lowermost part of the screen protecting film 100 to protect the cut-off portion 105 of the adhesive surface protecting layer 102.

Referring to FIG. 6 the cut-off portion 105 is removed, which is formed at an upper portion of the screen protecting film 100 and is a portion of the adhesive surface protecting layer 102 divided along the perforated line 104 formed at a side of the adhesive surface protecting layer 102. By removing the cut-off portion 105, a portion of the screen film 103 may be revealed. A position where the screen film 103 is to be attached onto the screen of the mobile phone may be determined by the revealed portion of the screen film 103 and a surrounding edge of the rest of the adhesive surface protecting layer 102.

For example, the rest of the adhesive surface protecting layer 102 may be positioned on the screen of the mobile phone, with the cut-off portion 105 removed, and the screen film 103 may be attached or fixed to an upper or lower end of the screen of the mobile phone via the adhesive surface partially exposed. The rest of the adhesive surface protecting layer 102 may then be removed, and the rest of the screen film 103 may be attached onto the rest of the screen of the mobile phone. Accordingly, the screen film 103 may be attached in place to the screen of the mobile phone.

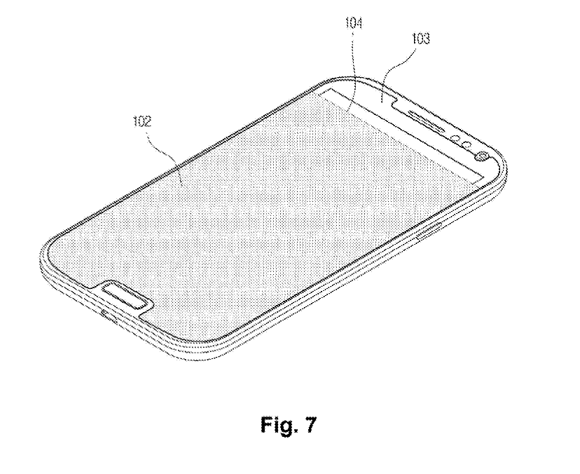

Referring to FIG. 7, an upper portion of the screen protecting film 100 may have an outer edge line corresponding to an edge line of the speaker and camera lens of the mobile phone. The adhesive surface exposed by removing the cut-off portion 105 is attached to an upper portion of the mobile phone so that the upper portion of the screen film 103 is consistent with or corresponds to the edge line of the speaker or camera lens of the mobile phone, allowing the screen protecting film 100 to be attached further exactly in place to the screen of the mobile phone.

Although in the above, example the cut-off portion 105 is formed in an upper portion of the screen protecting film 100, embodiments of the present disclosure are not limited thereto. For example, the cut-off portion 105 may be formed in a lower portion of the screen protecting film 100. When the cut-off portion 105 is formed in a lower portion of the screen protecting film 100, the screen protecting film 100 formed to fit an outer edge line of the home button of the mobile phone when the cut-off, portion 105 is removed may be attached to a lower portion of the screen of the mobile phone.

The adhesive surface protecting layer 102 may be a colored film. The colored adhesive surface protecting layer 102 may allow the user to determine an exact position where the screen film 103 is to be attached to the screen of the mobile phone, as illustrated in FIG. 7.

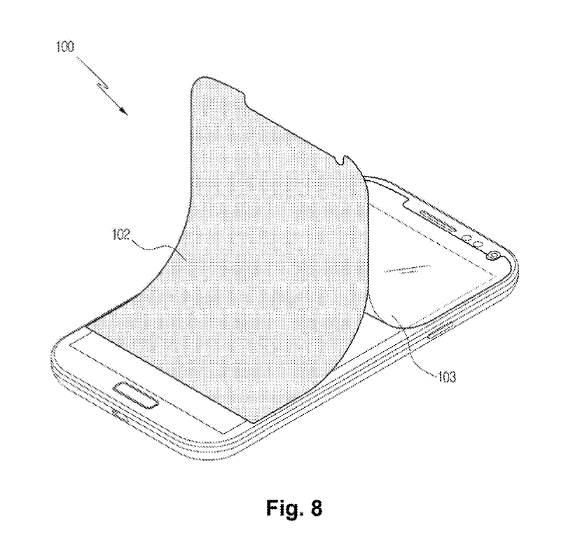

After determining the position where the screen film 103 is to be attached by the colored adhesive surface protecting layer 102, the rest of the adhesive surface protecting layer 102 may be removed, and the rest of the screen film 103 may be attached onto the screen of the mobile phone as illustrated in FIG. 8. Accordingly, the screen film 103 may be attached in place to the screen of the mobile phone in a convenient manner.

The exposed portion of the screen film 103 may be attached onto the screen of the mobile phone, and the rest of the screen film 103 may then be attached onto the screen of the mobile phone by removing the adhesive surface protecting layer 102. Thus, the screen film 103 may be neatly attached without changing the position of the attachment of the screen film 103.

A screen film protecting surface may be formed on a surface of the screen film 103 to prevent scratches on the surface of the screen film 103 or prevent dust or other foreign bodies from sticking to the surface of the screen film 103 upon manufacture, shipping, or attaching the screen film 103 to the screen of the mobile phone.

The screen protecting surface may be removed after the screen film 103 is attached to the screen of the mobile phone. The screen protecting surface may protect the screen film 103 against scratches or contaminants until the screen film 103 is attached to the screen of the mobile phone.

According to an embodiment of the present disclosure, there is provided a method for attaching a screen protecting film 100 onto a screen of a mobile phone using a colored adhesive surface protecting layer 102 and a perforated line 104. The method may include removing a cut-off portion 105 along the perforated line 104, determining and adjusting a position of attachment of a screen film 103 fitting an edge of a speaker area in an upper portion of the mobile phone using a portion of a screen film 103 exposed by removing the cut-off portion 105 and a remaining portion of the colored adhesive surface protecting layer 102, placing an adhesive surface of the exposed portion of the screen film 103, which corresponds to the cut-off portion 105, to correspond to the edge of the speaker area and attaching the exposed adhesive surface to an upper portion of a screen of the mobile phone, removing the remaining portion of the colored adhesive surface protecting layer 102 with the screen film 103 attached and fixed to the upper portion of the screen of the mobile phone, and attaching a remaining portion of the screen film 103 to the screen of the mobile phone after the adhesive surface protecting layer 102 is removed.

The protecting layer 101 may be formed under the adhesive surface protecting layer 102. The method further comprises removing the protecting layer 101 before removing the cut-off portion 105.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A method for attaching a screen protecting film onto a screen of a mobile phone using a colored adhesive surface protecting layer and a perforated line, the method comprising:
removing a cut-off portion along the perforated line;
determining and adjusting a position of attachment of a screen film fitting an edge of a speaker area, in an upper portion of the mobile phone using a portion of a screen film exposed by removing the cut-off portion and a remaining portion of the colored adhesive surface protecting layer;
placing an adhesive surface of the exposed portion of the screen film, which corresponds to the cut-off portion, to correspond to the edge of the speaker area and attaching the exposed adhesive surface to an upper portion of a screen of the mobile phone;
removing the remaining portion of the colored adhesive surface protecting layer with the screen film attached and fixed to the upper portion of the screen of the mobile phone; and
attaching a remaining portion of the screen film to the screen of the mobile phone after the adhesive surface protecting layer is removed.

2. The method of claim 1, wherein a protecting layer is formed under the adhesive surface protecting layer, and wherein the method further comprises removing the protecting layer before removing the cut-off portion.
